(19) United States
(12) Patent Application Publication
(10) Pub. No.: US 2023/0044032 A1
(43) Pub. Date: Feb. 9, 2023

(54) AUTOMATIC MULTI-LASER BORE-SIGHTING FOR RIFLE MOUNTED CLIP-ON FIRE CONTROL SYSTEMS

(71) Applicant: Cubic Corporation, San Diego, CA (US)

(72) Inventors: Tony J. Maryfield, Poway, CA (US); Mahyar Dadkhah, San Diego, CA (US); Christian Marcello Cugnetti, San Diego, CA (US); Michael Andre Roes, San Diego, CA (US)

(21) Appl. No.: 17/880,485

(22) Filed: Aug. 3, 2022

Related U.S. Application Data
(60) Provisional application No. 63/228,992, filed on Aug. 3, 2021.

(51) Int. Cl. F41G 3/06; F41G 3/08; G01S 7/481

(52) U.S. Cl. CPC F41G 3/065; F41G 3/08; G01S 7/4817; G01S 7/4815

(57) ABSTRACT

A multi-laser bore-sighting riflescope system can receive a first laser beam having a first wavelength and a second laser beam having a second wavelength smaller than the first wavelength. The system can detect reflected light from the first laser beam. The system can calculate an initial range to a target. The system can determine a ballistics solution. The system can find a ballistics aimpoint. Further, the system can illuminate a display of a riflescope display assembly (RDA). The system can mark the ballistics aimpoint with an electronic reticle on the display. The system can redirect the first laser beam to the ballistics aimpoint. The system can redirect the second laser to the ballistics aimpoint. The system can detect secondary reflected laser light from the first laser beam. The system can calculate a secondary range to the target.

This application claims the benefit of U.S. Provisional Application Ser. No. 63/228,992 by Maryfield et al, filed Aug. 3, 2021, entitled “AUTOMATIC MULTI-LASER BORE-SIGHTING FOR RIFLE MOUNTED CLIP-ON FIRE CONTROL SYSTEMS,” the disclosure which is incorporated by reference herein in its entirety.

### BACKGROUND OF THE INVENTION

This disclosure relates in general to optical scopes and, but not by way of limitation, to improved bore-sighting.

Weapon-mounted rangefinders are weapon-mountable electronic devices that determine a range between a weapon and a target by utilizing a laser transmitter and receiver unit to determine the round-trip time it takes a laser beam to travel to the target and back. These can be particularly useful in military and hunting applications. For sniper applications in the military, a range determined by a weapon-mounted rangefinder can be provided to a ballistic solver that uses the distance along with other factors (e.g., bullet mass, velocity, 25 weather conditions, etc.) to determine a ballistic solution that can be provided to a sniper to accurately aim the weapon before firing.

The ballistic solution can provide a ballistic aimpoint to assist a user to accurately aim the weapon. In some examples, the ballistic aimpoint may have a different range to the weapon than the original determined range. The different range may affect the accuracy of the ballistics solution as well as the accuracy of the ballistics aimpoint.

### BRIEF SUMMARY OF THE INVENTION

An example method for multi-laser bore-sighting of a ballistic solutions aimpoint with a multi-laser bore-sighting riflescope system, according to the description includes receiving, at a Risley prism assembly of a laser rangefinder, a first laser beam having a first wavelength and a second laser beam having a second wavelength smaller than the first wavelength, wherein the Risley prism assembly comprises one or more rotatable Risley prisms having a center portion and an annulus and the center portion has a wedge angle greater than a wedge angle of the annulus. The method further includes detecting, with a receiver unit of the laser rangefinder, reflected laser light from the first laser beam. The method also includes calculating an initial range to a target based at least in part on the detecting of the reflected laser light. The method further includes determining a ballistics solution based at least in part on the initial range. The method also includes finding a ballistics aimpoint based at least in part on the ballistics solution. The method further includes illuminating a display of a riflescope display assembly (RDA) configured to display the target. The method also includes marking the ballistics aimpoint with an electronic reticle on the display. The method further includes redirecting the first laser beam to the ballistics aimpoint using the center portion of the one or more rotatable Risley prisms. The method also includes redirecting the second laser beam to the ballistics aimpoint using the annulus of the one or more rotatable Risley prisms. The method also includes, upon redirecting the first laser beam, detecting, with the receiver unit, secondary reflected laser light from the first laser beam. The method further includes calculating a secondary range to the target based at least in part on the detecting of the secondary reflected laser light.

An example multi-laser bore-sighting riflescope system, according to some embodiments comprises a first laser configured to emit a first laser beam having a first wavelength. The riflescope system further includes a second laser configured to emit a second laser beam having a second wavelength shorter than the first wavelength. The riflescope system also includes a

Risley prism assembly comprising one or more rotatable Risley prisms having a center portion and an annulus, wherein the center portion has a wedge angle greater than a wedge angle of the annulus, wherein the first laser is configured to emit the first laser beam through the enter portion of the one or more rotatable Risley prisms and the second laser is configured to emit the second laser beam through the annulus of the one or more rotatable Risley prisms. The riflescope system further includes a riflescope display assembly (RDA) comprising a display configured to display a target, the display comprising an electronic reticle configured to mark a ballistics aimpoint.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is an illustration of an example weapon-mounted range-finding configuration, according to an embodiment.

FIG. 2 is a simplified isometric diagram of a Risley prism assembly that can be included in the laser rangefinder system and to help ensure co-alignment between a range-finding laser beam and a visible laser beam after adjustment of the range-finding laser beam, according to an embodiment.

FIG. 3 is a simplified cross-section of a first laser transmitter, providing an additional perspective of how a Risley prism assembly similar to the one shown in FIG. 2 can be used in a laser rangefinder system, according to an embodiment.

FIG. 4A is a simplified cross-section of a second laser transmitter, according to an embodiment.

FIG. 4B is a close-up cross-sectional view of a top portion of an embodiment of a three-wedge Risley prism

FIG. 5 is a block diagram of various electrical components of a multi-laser bore-sighting riflescope system, according to an embodiment.

FIG. 6A and 6B illustrate a flow diagram of a method 600 of multi-laser bore-sighting of a ballistic solution aimpoint, according to an embodiment

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Presently, laser range finders (LRF) and ballistic computers are typically zero'd to the rifle for bullet drop at 100 m targets. Long range targets are typically engaged with high performance, high magnification riflescopes to both clearly observe the target as well as provide an accurate aim point of the fire control system for snipers or commercial hunters. As an example, a 1 km range may result in a gun elevation of 13 mils and when magnified 25×, the 100 m boresight is now out of the target field of view. The shooter has two options, (1) Re-boresight the LRF at the new range to keep the scope, rifle, and LRF co-aligned at the same scope reticle position, or (2) switch the turrets back to 100 m zero and re-range the target. This may result in an un-timely or missed shots for targets that could move away, or other features such as target tracking, or crosswind corrected shots. It is an inconvenience, and unnecessary confusion in any regard for the shooter.

“Smart scopes” is a class of fire control riflescopes that provides an overlay of the ballistically corrected aiming coordinates based on target range, gun/bullet type, and atmospheric conditions. A “clip-on display” riflescope display assembly (RDA) instantly converts a traditional riflescope into a “smart scope” with the beam splitter in the objective space.

In one embodiment, a solution is presented here that automatically aligns the LRF aimpoint to the ballistic solution/targeting display, freeing the shooter to concentrate on the target instead of keeping tracking of the gun, scope, and fire control system. This solution electronically steers the laser beam(s) using Risley prisms to the aim point solution and updates with each new ballistic aim point solution. That way the user is free to move the scope turrets and zoom where he wishes and still be able to re-range the target at the previous electronic aimpoint. The solution relies on the angular coordinates of the electronic reticle, which is in object space in front of the scope and is independent of the state of the scope fixed grid or zoom, but accurately dependent on the co-alignment of the scope/display and rifle/bullet hit point at 100 m. The angular transfer function of the Risley prisms is then proportional to the electronic reticle, making it possible to point the lasers at any angular coordinate reported in the electronic reticle, e.g. the target aimpoint. The internal offsets and scale factors are fixed and co-aligned in manufacture of the electronic clip-on display and built in LRF with integral Risley prisms. This presumes an integrated ballistic laser range finder (prior art) clip-on with an electronic reticle and ballistic solver. The ballistic laser range finder incorporates a wide field of view APD receiver and does not need to be steered—only the laser, making this auto bores-sighting/target tracking improvement possible.

As a further feature, the beam steering system is comprised on a stack of servo controlled Risley Prisms (prior art), but allows a plurality of lasers to track the target: red alignment laser, 880 nm Flood laser, 880 spot laser, and the 1550 nm laser range finder (all maintaining co-alignment). The co-alignment of the built-in lasers and electronic display incorporates a calibration factor that enables the laser to be accurately pointed at any angular location of the electronic aim point. This feature may offer advantages for target tracking applications with live range updates in one embodiment.

Integrating a host of lasers and a laser rangefinder into an electronic heads up display provides that the angular position of the displayed firing solution can also be used to steer the LRF and other lasers onto the target. They are both directly co-aligned and proportional to each other, making it possible for conventional servo controls to move the Risley prisms as prescribed and accurately move one or more laser beams simultaneously to a target aimpoint.

In another embodiment, a multiple of lasers of differing wavelengths can be co-aligned and steered with a concentric stack of Risley prisms, which are inherently shock proof and hold boresight as demonstrated in live fire tests. The novelty of this feature is that the shooter no longer needs to return to his original scope/rifle zero at 100 m to range the target. In fact, the shooter is free to engage at any range, and the LRF is essentially tracking the new aimpoint and instantly ready for a range and ballistic solution update. This is a convenience feature, but it also reduces target engagement time, allowing rapid updates and timely shots to the target.

Bore-sighting the RDA to the riflescope/gun automatically boresights the LRF and accessory lasers (IR pointing, illumination, red laser, and LRF lasers) in one step. Provides the ability to track a target in real time and provide real time target range data and fire control ballistic solutions in one embodiment.

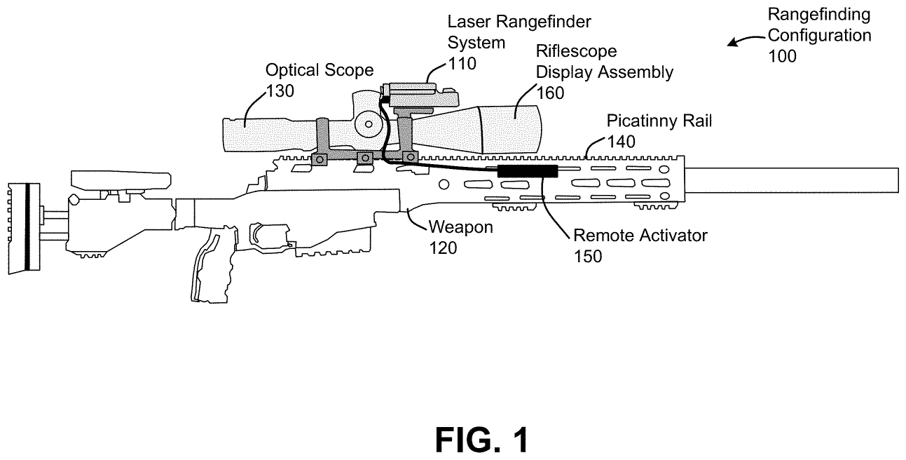

FIG. 1 is an illustration of an example weapon-mounted rangefinding configuration 100, according to an embodiment. Here, a laser rangefinder system 110 is mounted on a weapon 120 above an optical scope 130. A riflescope display assembly (RDA) 160 is attached to the optical scope 130. Here, both the laser rangefinder system 110 and optical scope 130 are mounted to the weapon 120 via a Picatinny rail 170 (which offers a standard rail interface system for mounting firearm accessories). They can be understood that embodiments may accommodate different configurations. For example, the laser rangefinder system 110 may be mounted in front of or below the optical scope 130. Moreover, alternative configurations may omit the optical scope 130 entirely. In alternative configurations, the laser rangefinder system 110 may be mounted to a spotting scope or other non-weapon apparatus.

Although embodiments of the laser rangefinder system 110 may include a user interface (e.g., buttons, switches, display, etc.), embodiments may additionally or alternatively include an interface by which a remote activator 150 may be coupled to the laser rangefinder system 110 to provide a basic input to the laser rangefinder system 110. As illustrated in FIG. 1, for example, the remote activator 150 comprises a mountable button, switch, touchpad, and/or other user-activated interface communicatively coupled with the laser rangefinder system 110. The remote activator 150 can be mounted to an easily reachable location on the weapon 120 to allow a user to initiate range-finding by the laser rangefinder system 110 while viewing a target through the optical scope 130. That is, because both the laser rangefinder system 110 and optical scope 130 may be bore-sighted to the weapon 120, a user can view a target through the optical scope 130 and activate the remote activator 150 to cause the laser rangefinder system 110 to determine a range to the target, and provide the range to the user. The range may be provided within a display of the RDA 160 viewable through the optical scope 130. The laser rangefinder system 110 may have an electronic interface to allow the laser rangefinder system 110 to communicate the range to a display of the RDA 160. This can allow a user to determine the range of a target viewable within the optical scope 130 without having to look elsewhere for the range determination.

Keeping the laser rangefinder system 110 aligned with the weapon 120 from initial calibration can be difficult, especially once the weapon 120 is fired. Shock loads caused by the weapon 120 firing can cause bore-sight errors and shifts after each shot. Bore-sighting the laser rangefinder system 110 again to the weapon 120 can be done via manual or automatic adjustments to one or more components of the laser transmitter (e.g., causing an adjustment to the orientation of an optical element or the laser itself) to adjust the direction of the outgoing laser beam. (These adjustments may be made, for example, by manually moving knobs on the rangefinder 100.) However, because a range-finding laser beam 140 is typically invisible to the human eye (especially in military applications), it can be difficult to bore-sight the laser rangefinder system 100 again to the weapon 120 without special equipment. As an example, the range-finding laser beam may have a wavelength of 1550 nm, which can be generated by a relatively low-cost, high-performance laser. Moreover, the 1550 nm wavelength is a hard-to-detect, and eye-safe wavelength that can perform well under atmospheric scintillation. That said, a person of ordinary skill in the art will appreciate that the range-finding laser beam 140 may comprise an alternative wavelength.

According to embodiments herein, a laser rangefinder system 110 may include multiple wavelength lasers, including a visible laser, which can facilitate bore-sighting the laser rangefinder system 110 to the weapon 120. For the range-finding functionality, the wavelength may be invisible (e.g., at 880 nm, 904 nm, or 1550 nm) and therefore embodiments may additionally use a visible aiming laser (e.g., 663 nm) that is switched on whenever the laser rangefinder system 110 is to be bore-sighted to the weapon 120, assuming that the visible laser is pre-aligned to the invisible range-finding laser. Because it is visible, the user can then boresight the laser rangefinder 100 to the weapon 120, without the use of special equipment. (In some scenarios, all that may be needed is a reflective surface so the user can project and view the red laser spot at the target.) Additional lasers for designation (e.g., 1064 nm, etc.) may be used as well, depending on the application. All stay aligned to the common reference point (e.g., the riflescope crosshairs). In some examples, the common reference point can be a ballistic aimpoint determined at least in part on a ballistics solution. In some embodiments, the laser rangefinder system 110 and the RDA 160 can be combined within a single housing. For example, the RDA 160 can include all components of the laser rangefinder system 110 in some embodiments.

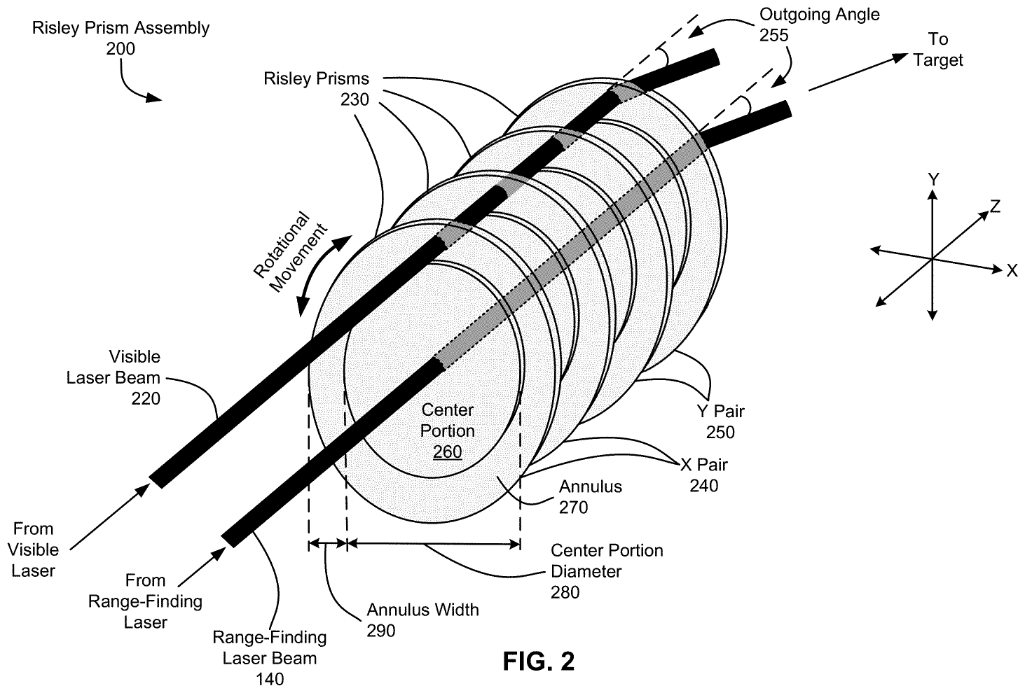

FIG. 2 is a simplified isometric diagram of a Risley prism assembly 200 that can be included in the laser rangefinder system 110 and to help ensure co-alignment between a range-finding laser beam 140 and a visible laser beam 220 after adjustment of the range-finding laser beam 140, according to an embodiment. For clarity, orientation of the various illustrated components is described with respect to mutually-orthogonal X, Y, and Z axes, as shown. Here, the Risley prism assembly 200 comprises four rotating optical wedge prisms (commonly known as “Risley prisms,” and labeled as Risley prisms 230 in FIG. 2), including an X pair 240 and Y pair 250. Rotational movement (as shown) of these Risley prisms 230 about the Z-axis steer both the range-finding laser beam 140 and the visible laser beam 220 along at an outgoing angle 255 along X and Y directions. (Here, the outgoing angle 255 is defined by the difference in direction of laser beams 140 and 220 prior to being redirected by the Risley prism assembly 200 with the direction of the laser beams 140 and 220 after being redirected by the Risley prism assembly 200. As noted, the outgoing angle 255 is substantially the same for both laser beams 140 and 220.) More specifically, the X pair 240 of Risley prisms 230 can be configured to, when rotated in opposite directions about the Z-axis (e.g., the first Risley prism 230 of the X pair 240 rotates in a clockwise manner and the second Risley prism 230 of the X pair 240 rotates in a counterclockwise manner), adjust the angle of both the range-finding laser beam 140 and visible laser beam 220 relative to the X-axis. Similarly, the Y pair 250 of Risley prisms 230 can be configured to, when rotated in opposite directions about the Z-axis, adjust the angle of both the range-finding laser beam 140 and a visible laser beam 220 relative to the Y axis. Pairs of Risley prisms 230 can be disposed in rotating elements (not shown) that engage with a single gear, in some embodiments, providing for equal rotation in opposite directions. Different gears may be used for adjusting the X pair 240 and the Y pair 250, allowing a user to adjust the laser beams 140 and 220 in X and Y directions independently. (As previously mentioned, these gears may be adjusted using a screwdriver or similar means, and multiple gears and gear ratios may be used to provide a convenient adjustment level for users).

Because the range-finding laser beam 140 and a visible laser beam 220 utilize different wavelengths, traditional Risley prisms comprising a single optical wedge prism (also referred to herein simply as a “wedge”) would result in steering these two beams in different directions. That is, Risley prisms can cause increasing spread of the beam position between beams of two or more of differing wavelengths moving through the same aperture. For example, a range-finding laser beam 140 having a 1550 nm wavelength steered 12 milliradians by the BK7 glass wedges, a corresponding visible laser beam having a 633 nm wavelength would be steered 34 milliradians, making the true location of the range-finding laser beam uncertain. That is, if a laser rangefinder system 110 steered to both visible and range-finding laser beams using traditional Risley prisms, a user may be able to steer the visible laser onto a target 130 during a bore-sighting process but would not have any idea of where the range-finding laser beam 140 would be. This would result in the laser rangefinder 100 being inaccurate for many applications, especially long-distance applications.

To help maintain co-alignment between the range-finding laser beam 140 and visible laser beam 220, each Risley prism 230 can comprise two differently-sized circular wedges coupled with each other as shown in FIG. 2. Put differently, each Risley prism 230 in the Risley prism assembly 200 may comprise a compound or composite Risley prism having a center portion 260 comprising the portion of the Risley prism 230 for which a laser beam traveling substantially along the Z direction passes through both circular wedges of the Risley prism 230, and an annulus 270 comprising the portion of the Risley prism 230 for which a laser beam traveling substantially along the Z direction passes through the larger circular wedge only.

According to some embodiments, the laser rangefinder system 110 can include a receiver unit comprising a wide field of view (FOV) optical sensor. That is, the FOV of the optical sensor may be fixed, relative to the body of the laser rangefinder system 110. However, the FOV of the optical sensor may be wide enough to accommodate adjustments in the direction of the transmitted range-finding laser beam 140 caused by the Risley prism assembly 200, and thereby capable of making range-finding measurements regardless of how the outgoing range-finding laser beam 140 is steered. An example of a wide FOV optical sensor can be found in U.S. Pat. No. 8,558,337, entitled “WIDE FIELD OF VIEW OPTICAL RECEIVER,” which is hereby incorporated by reference in its entirety for all purposes. This type of wide FOV optical sensor can provide, for example, a 2° FOV within the operating range of the laser rangefinder system 110, which may be sufficient to accommodate any adjustments to the range-finding laser beam made 140 by the Risley prism assembly 200.

The size of the Risley prisms 230 and aperture for the laser rangefinder system 110 may vary, depending on the laser spot size, desired divergence wavelength of the range-finding laser beam 140 and visible laser beam 220 (and/or other laser beams, as described herein below), desired divergence, and/or other factors. For a range-finding laser beam 140 having a 1550 nm spot size, a center portion 260 having a center portion diameter 280 of 10 mm would result in a beam divergence of 300 μrad, which may be satisfactory in many applications. The center portion diameter 280 may be increased or decreased to result in a different corresponding beam divergence, if desired. A visible laser, which has a much smaller wavelength and spot size, may need an aperture (and annulus width 290) of only 2-3 mm. The total diameter of the Risley prism would be the center portion diameter 280 plus two times the annulus width 290. Thus, the diameter of a Risley prism 230 having a center portion diameter 280 of 10 mm and annulus width 290 of 3 mm, would be 16 mm. (Having a third, laser beam with an intermediate wavelength of approximately 880 nm (as described in more detail below) would roughly double this diameter size.)

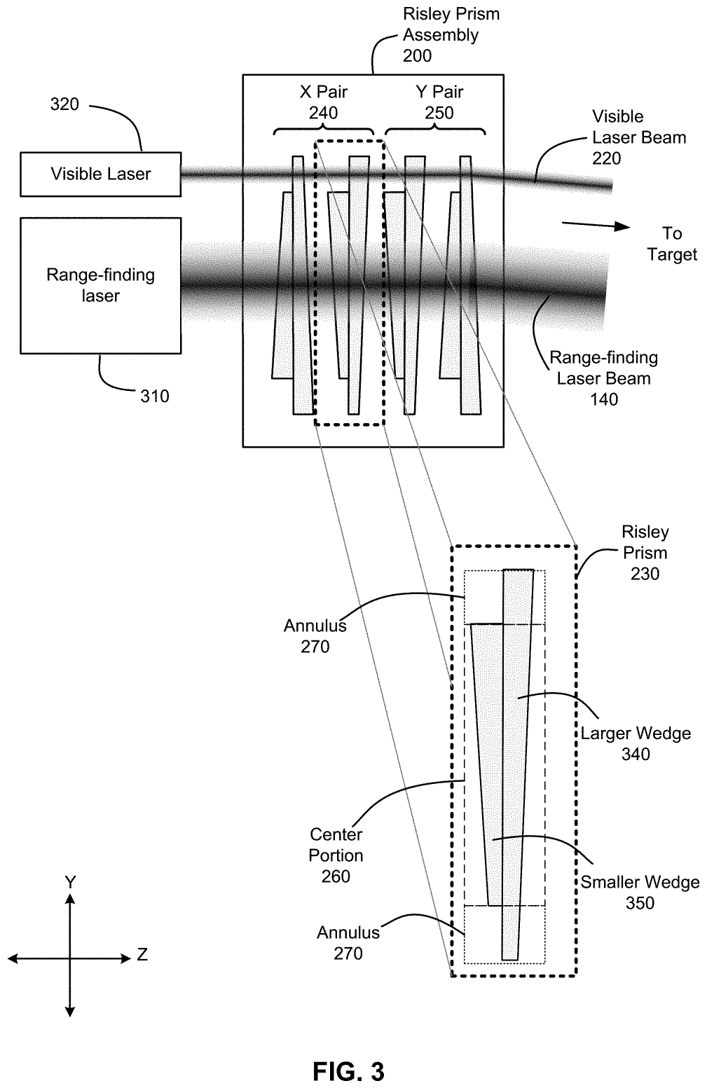

FIG. 3 is a simplified cross-section of a first laser transmitter 300-A, providing an additional perspective of how a Risley prism assembly 200 similar to the one shown in FIG. 2 can be used in a laser rangefinder 100, according to an embodiment. Here, the laser transmitter 300-A (which may be disposed within the body of the laser rangefinder system 110, along with a receiver unit and other components) comprises a range-finding laser 310 (which emits the range-finding laser beam 140), a visible laser 320 (which emits a visible laser beam 220, which can be used for bore-sighting), and a Risley prism assembly 200, similar to the one shown in FIG. 2. (Embodiments of a laser transmitter 300-A may include other optics, but they are omitted here, to avoid clutter.)

As previously noted, to be able to steer both the range-finding laser beam 140 and bore-sighting laser beam 220 in the same direction, each Risley prism 230 of the Risley prism assembly 200 may comprise wedge pairs (or, optionally, monolithic optical elements with similar optical properties). As shown in FIG. 3, (and previously mentioned), each Risley prism 230 may comprise a larger wedge 340 and a smaller wedge 350 concentrically coupled to provide a center portion 260 (comprising both the larger wedge 340 and the smaller wedge 350) through which the range-finding laser beam 140 travels, and an annulus 270 (comprising the larger wedge 340 only) through which the visible laser beam 220 travels. As noted, the dimensions of the larger wedge 340 and smaller wedge 350 can be configured to compensate for wavelength differences in the range-finding laser beam 140 and visible laser beam 220. Each wedge may have an anti-reflective (AR) coating to help reduce reflection.

For example, a 1550 nm beam (e.g., range-finding laser beam 140) would need roughly twice the wedge angle as required for a 633 nm beam (e.g., visible laser beam 220) to steer the 1550 nm beam in the same direction. The dimensions of the larger wedge 340 and smaller wedge 350 may therefore be adjusted accordingly. The aperture for the range-finding laser beam 140 may be generally much larger than the visible laser beam 220 due to wavelength, and lasers can fit well in the shared aperture illustrated in FIG. 2. Additional details regarding aperture dimensions are provided herein below.

In construction, the Risley prisms 230 of the Risley prism assembly 200 may be laminated to help secure the relative positions of the larger wedge 340 with respect to the smaller wedge 350, thereby helping ensure the wedge angles of the Risley prisms are additive in the center portion 260 and not additive in the annulus 270. Additionally or alternatively, specialized (e.g., monolithic) Risley prisms may be fabricated to provide substantially the same functionality as the additive wedges illustrated in FIG. 3. The position of the range-finding laser 310 may be fixed within the body of the laser rangefinder 100 relative to the Risley prism assembly 200 to help ensure the range-finding laser beam 140 passes only through the center portion 260 of each Risley prism 230 of the Risley prism assembly 200. Similarly, the position of the visible laser 320 may be fixed relative to the Risley prism assembly 200 to help ensure the visible laser beam 220 passes only through the annulus 270 of each Risley prism 230 of the Risley prism assembly 200.

Properly constructed, when the wedges are turned for beam steering during bore-sighting, both the visible laser beam 220 and range-finding laser beam 140 can move in unison and with substantially the same deflection angles. This can therefore allow bore-sighting of an indivisible range-finding laser beam 140 by using a visible reference beam (visible laser beam 220).

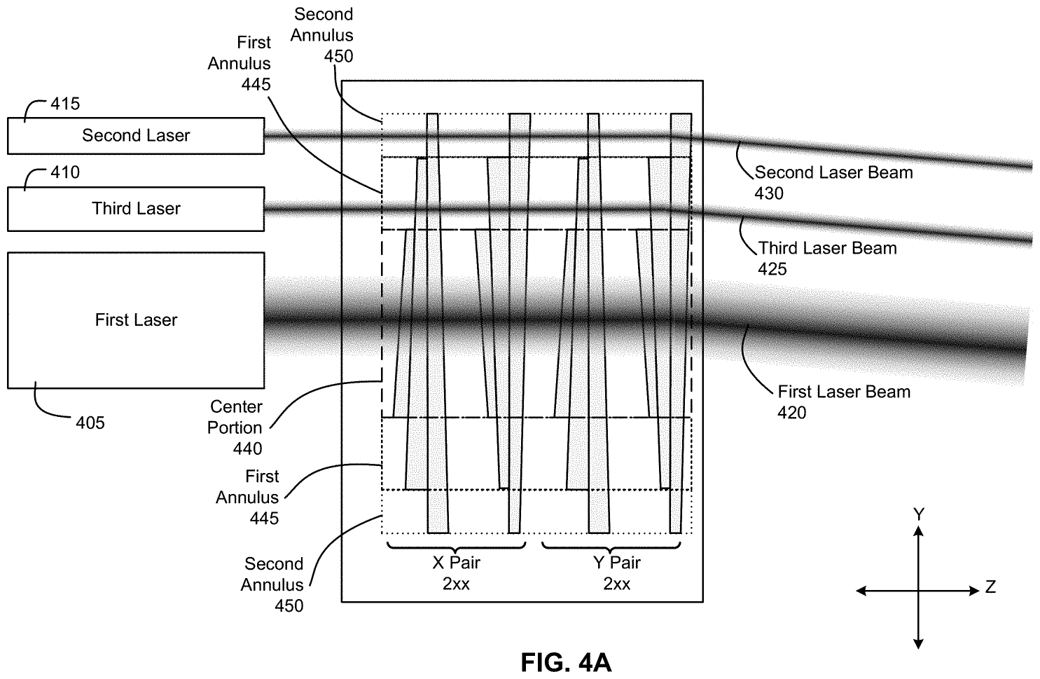

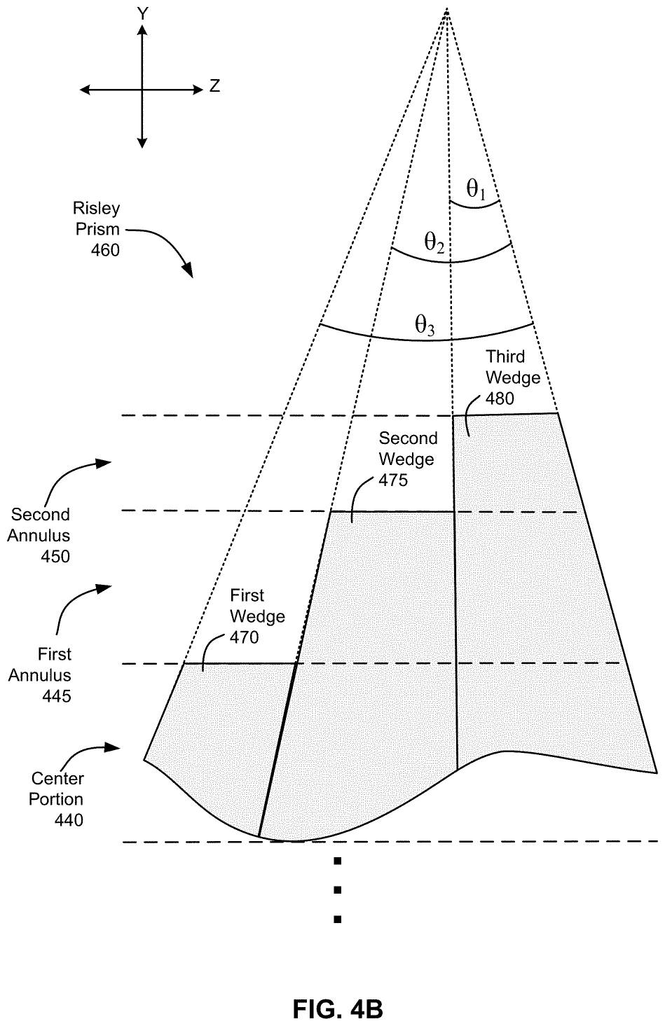

It can be noted that alternative embodiments may use more than two lasers and/or use different Risley prisms. An example of this is shown in FIGS. 4A and 4B.

FIG. 4A is a simplified cross-section of a second laser transmitter 300-B, similar to the first laser transmitter 300-A of FIG. 3, but with an additional laser. That is, the laser transmitter 300-B of FIG. 4A has a first laser 405, a second laser 415, and third laser 410, where the respective first laser beam 420, third laser beam 425 and second laser beam 430 have progressively smaller wavelengths. Thus, to steer each of the laser beams similarly, the Risley prism assembly 435 comprises Risley prisms having three optical wedges forming a center portion 440 through which the first laser beam 420 travels, a first annulus 445 through which the third laser beam 425 travels, and a second annulus 450 through which the second laser beam 430 travels.

A three-laser system as shown in FIG. 4A can be utilized in military and other applications. For example, the first laser 405 may comprise a range-finding laser emitting a 1550 nm wavelength beam, the third laser 410 may comprise a designation laser emitting a 904 nm or 880 nm wavelength beam for laser target designation, and the second laser 415 may comprise a visible laser emitting a 633 nm (red) beam for bore-sighting. This can allow a laser rangefinder system 110 to be multipurpose: providing range and laser target designation functionality.

In principle, other embodiments may use Risley prisms 230 with additional wedges to allow for the use of yet additional lasers to perform additional functions (e.g., high-speed optical communication, Friend or Foe (IFF) functionality, etc.). That is, building on the principles described herein, Risley prisms can provide combination wedge angles that may be progressively steeper for the longer wavelengths (according to Snell's law). Wedges for each composite Risley prism 230 can be bonded (laminated) for combined stepped wedges.

FIG. 4B is a close-up cross-sectional view of a top portion of an embodiment of a three-wedge Risley prism 460, which may be used in the laser transmitter 300-B of FIG. 4A, provided here to help illustrate the additive wedge angles of each wedge of the Risley prism 460. As with other figures provided herein, the dimensions of FIG. 4B are not to scale, but are provided for explanatory purposes. Moreover, it will be understood that, although wedge angles illustrated are shown to converge at a single point, no such convergence may take place in alternative embodiments.

Here, the top portion of the three-wedge Risley prism 460 is illustrated, showing top portions of the second annulus 450, first annulus 445, and center portion 440, similar to corresponding portions illustrated in FIG. 4A. A first wedge 470 is the smallest, and is found only in the center portion 440. A second wedge 475 is larger, and the portion of the second wedge 475 that overlaps with the first wedge 470 (along the Y direction) forms the first annulus 445. The third wedge 480 is larger still, and the portion of the third wedge 480 that overlaps with the second wedge 475 (again along the Y direction) forms the second annulus 450.

The wedge angles of each of the three wedges illustrated in FIG. 4B are additive for the purposes of steering light traveling substantially along the Z direction. Thus, the wedge angle of the second annulus 450, θ₁, is simply the wedge angle of the third wedge 480. However, the wedge angle of the first annulus 445, θ₂, is the combined wedge angles of the second wedge 475 and the third wedge 480. Lastly, the wedge angle of the center portion 440, θ₃, is the sum of the wedge angles of all three wedges.

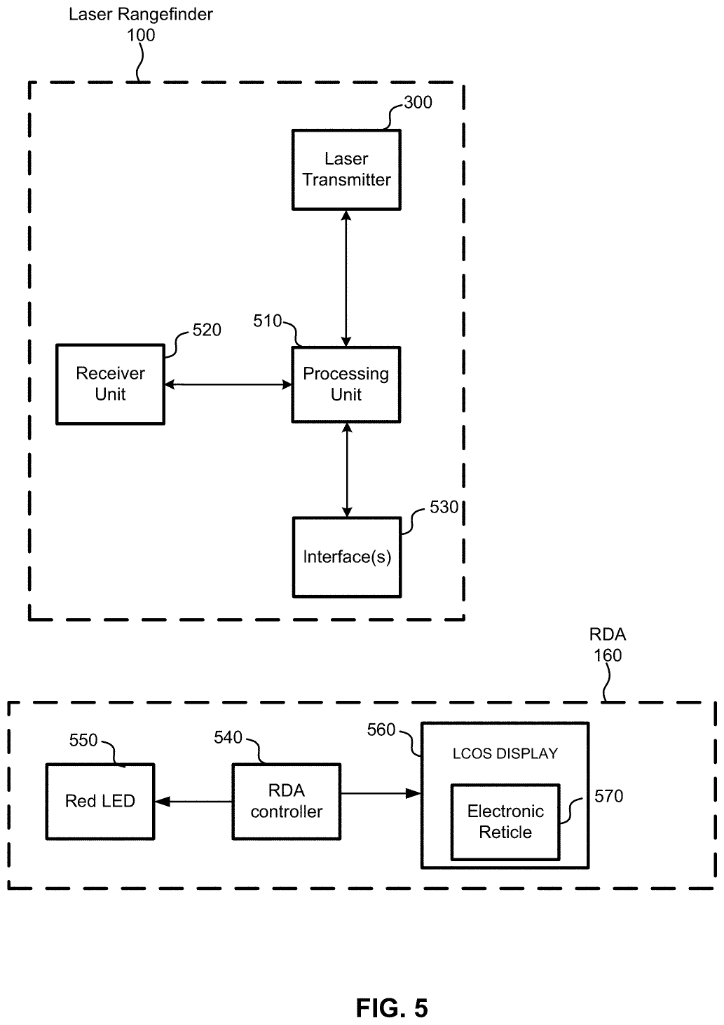

FIG. 5 is a block diagram of various electrical components of a multi-laser bore-sighting riflescope system 500, according to an embodiment. Here, the laser rangefinder system 110 comprises a processing unit 510, laser transmitter 300 (which can comprise components as shown in the laser transmitter 300-A of FIG. 3, laser transmitter 300-B of FIG. 4A, or the like, including a Risley prism assembly 200 as illustrated in FIG. 2, for example), a receiver unit 520, and interface(s) 530. Arrows between components represent communication pathways. It will be understood that, in alternative embodiments, a laser rangefinder system 110 may include additional or alternative components. Moreover, the laser rangefinder system 100 may include optical elements not illustrated, such as lenses, prisms, etc. Depending on desired functionality, the laser rangefinder system 110 may be weapon-mountable, may include other components to provide additional functionality, etc. It will be further understood that additional variations to the embodiment illustrated in FIG. 5 may include combining or separating various components, adding or omitting components, and the like. Depending on desired functionality, embodiments may include an internal power source, such as a battery, and/or utilize an external power source.

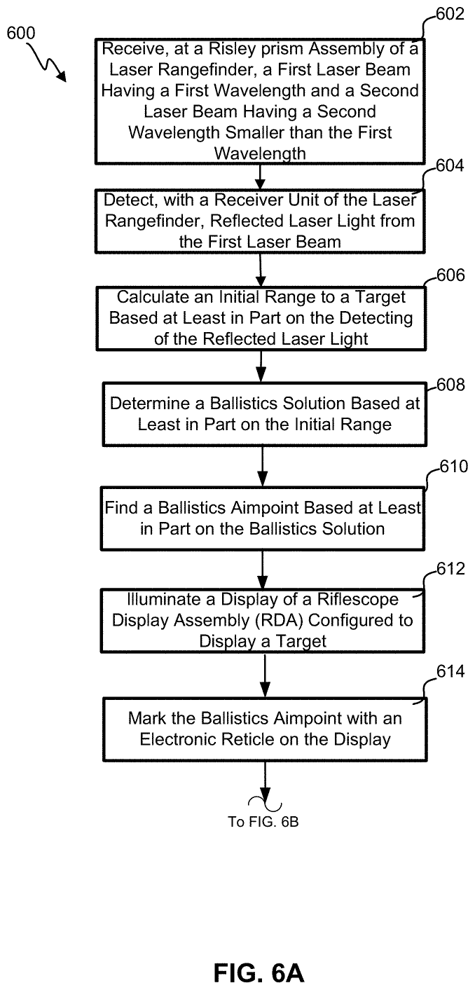

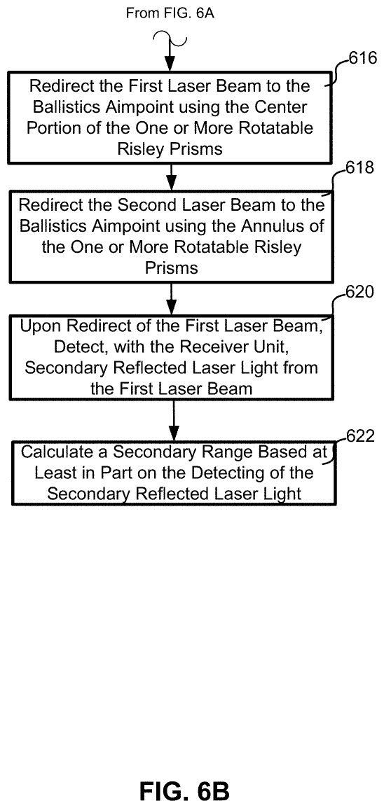

According to embodiments, one or more of the components illustrated in FIG. 5 may perform one or more functions of the methods provided herein, including the method illustrated in FIG. 6 and described below.

The multi-laser bore-sighting riflescope system 500 can also include an RDA 160. The laser rangefinder system 110 may have an electronic interface to allow the laser rangefinder system 110 to communicate the range to a display of the RDA 160. In this example, the RDA 160 comprises an RDA controller 540, a red light emitting diode (LED) 550 and a liquid crystal on silicon (LCOS) display 560. The RDA controller 540 may comprise one or more processors generally configured to cause the various components of the RDA 160 to mark a ballistics aimpoint with an electronic reticle 570 of the LCOS display 560, calculate a ballistic solution (according to some embodiments), and operate a user interface. The RDA controller 540 may comprise without limitation one or more general-purpose processors (e.g. a central processing unit (CPU), microprocessor, and/or the like), one or more special-purpose processors (such as digital signal processing (DSP) chips, application specific integrated circuits (ASICs), and/or the like), and/or other processing structure or means.

One or more individual processors within the RDA controller 540 may comprise memory, and/or the RDA controller 540 may have a discrete memory (not illustrated). In any case, the memory may comprise, without limitation, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like

In the embodiment illustrated, the processing unit 510 is communicatively coupled to the various other components, as represented by the double arrows in FIG. 5, via a bus, direct connection, or the like. The processing unit 510 may comprise one or more of an application specific integrated circuit (ASIC), a field programmable gate array (FPGA), a general purpose processor, microprocessor, or the like, which may be included in a single physical unit (e.g., a single integrated circuit (IC)) or distributed among various processing elements.

The processing unit 510 is in communication with the laser transmitter 300 to generate the laser beam(s) and/or steer the laser beam(s) during bore-sighting, as described herein. As noted, some embodiments may have a manually-adjustable Risley prism assembly where Risley prisms may be adjusted manually by a user (e.g., by turning a knob with a screwdriver or fingers for each pair of Risley prisms). Additionally or alternatively, however, the Risley prisms of the Risley prism assembly may be steered automatically by the processing unit, which may control servos that rotate the Risley prisms. Depending on desired functionality, the processing unit 510 may communicate separately with the lasers and servos, or may simply communicate with the laser transmitter 300, which may have its own processing unit.

According to some embodiments, the processing unit 510 may include a memory (e.g. comprising a non-transitory computer-readable medium) that may store and execute computer code, such as software, firmware, and the like. As such, the processing unit 510 may comprise software components that, when executed by hardware elements of the processing unit 510, enable the processing unit 510 to provide the functionality described herein. This can include, for example, coordinating the transmission and reception of laser beams by the laser transmitter 300 and receiver unit 520, determination of a range based on the timing of the laser transmission by the laser transmitter 300 and reception by the receiver unit 520, determination of the ballistic solution based on range and other data (where the other data may be obtained from sensors of the laser rangefinder system 110 (not shown) or received via the interface(s) 530), and/or similar functions. In some examples, the range and other data can be communicated from the laser rangefinder system 110 to the RDA controller 540 and the RDA controller 540 can determine the ballistic solution.

The receiver unit 520 may comprise optical and electronic components configured to receive a reflected laser beam in the manner described herein. As such, the receiver unit 520 may comprise one or more photosensitive elements, such as an avalanche photodiode or a PIN photodiode. The output of these elements may be provided to a processing unit (e.g., processing unit 510 or an external processing unit) for calculating range. As noted, for embodiments in which the receiver unit 520 comprises a wide FOY optical sensor, the wide FOY optical sensor may be in a fixed position in or on the laser rangefinder system 110. Alternatively, for embodiments where the laser transmitter 300 is capable of steering a range-finding laser beam 140 outside the FOY of the optical sensor (for a target 130 within the operable range of the laser rangefinder system 110), the laser rangefinder system 110 may be capable of jointly steering the optical sensor so that it is substantially co-aligned with the outgoing range-finding laser beam 140 (and thereby capable of receiving the reflected laser beam from the target 130).

The interface(s) 530 of the laser rangefinder system 110 may comprise one or more of a variety of types of interfaces, depending on desired functionality. For instance, the interface(s) 560 may comprise a user interface configured to receive an input from a user to conduct range-finding. Thus, the interface(s) 530 may comprise a button, switch, touch-pad, touchscreen, and/or other input device. The interface(s) 530 may further include an output device, such as an LED, display, etc., enabling the laser rangefinder system 110 to indicate the calculated range. Additionally or alternatively, the interface(s) 530 may comprise a communication interface enabling communication with another device, such as the RDA 160. Such a communication interface can allow the laser rangefinder system 110 to receive input from and/or provide output to a separate device, in which case the laser rangefinder system 110 may conduct range-finding based on input received from the separate device and/or provide the determined range to the separate device via the interface(s) 530. The communication interface can include communication circuitry for wired (e.g., Universal Serial Bus (USB) interface, serial interface, etc.) and/or wireless (Bluetooth®, Wi-Fi (IEEE 802.11), Near Field Communication (NFC), etc.) communication.

FIGS. 6A and 6B illustrate a block diagram of a method 600 of multi-laser bore-sighting of a ballistic solution aimpoint, according to an embodiment. As with other figures provided herein, FIG. 6 is provided as a non-limiting example; alternative embodiments may include additional or alternative functionality. Functions described in the blocks illustrated in FIG. 6 may be performed by Risley prisms in a Risley prism assembly (e.g., as shown in FIGS. 2, 3, and 4A, for example) and/or other components of a laser transmitter or laser rangefinder system 110 as well as an RDA 160, as described herein.

At block 602, the functionality comprises receiving, at a Risley prism assembly 200 of the laser rangefinder system 110, a first laser beam 420 having a first wavelength and a second laser beam 430 having a second wavelength smaller than the first wavelength. Further, as noted in the embodiments described above, the Risley prism assembly 200 comprises one or more rotatable Risley prisms having a center portion 260 and an annulus 270, and the center portion 260 has a wedge angle greater than a wedge angle of the annulus 270. In some embodiments, each rotatable Risley prism of the one or more rotatable Risley prisms may comprise a larger optical wedge coupled with a smaller optical wedge. In such instances, according to some embodiments, for each rotatable Risley prism of the one or more rotatable Risley prisms, the respective larger optical wedge is coupled with the smaller optical wedge such that the center portion 260 of the respective rotatable Risley prism comprises a portion where the respective smaller optical wedge is coupled with the larger optical wedge, and the annulus 270 of the respective rotatable Risley prism comprises a portion where the respective larger optical wedge overlaps the respective smaller optical wedge.

At block 604, the functionality comprises detecting, with a receiver unit 520 of the laser rangefinder system 110, reflected laser light from the first laser beam 420. In some examples, the reflected laser light can comprise a plurality of reflected laser pulses corresponding to a plurality of laser pulses transmitted with a fiber laser reflecting off a target, wherein the receiver unit 520 directs the reflected laser light toward a light sensor. The receiver unit 520 may comprise optics such as a sun filter and/or an immersion lens. The light sensor may comprise an avalanche photodiode (APD) or other photoelectric sensor.

The functionality at block 606 comprises calculating an initial range to the target based at least in part on the detecting of the reflected laser light. The range can be determined based on the time at which the reflected laser light was detected by the light sensor. In some examples, utilization of a plurality of laser pulses can provide for a particularly accurate range determination. For example, the determination of the distance from the laser rangefinder system 110 to the target may be based on an average time of flight of the plurality of laser pulses. According to some embodiments, the method 600 may further comprise providing, with an output interface of the laser rangefinder system 110 or a display of the RDA 160, an indication of the calculated initial range.

At block 608, the functionality comprises determining a ballistics solution based at least in part on the initial range. In some examples, the ballistics solution may be based on environmental factors as well. As such, according to some examples, the method 600 may further comprise obtaining environmental information from an environmental sensor and determining, with the processing unit of the laser rangefinder system 110, a ballistic solution based on the initial range to the target and the information from the environmental sensor. The environmental sensor itself may comprise one or more types of sensors configured to sense one or more types of environmental factors. According to some examples, the environmental sensor comprises an inclinometer, thermometer, barometer, humidity sensor, compass (e.g., magnetometer), wind sensor, or any combination thereof. In some examples, the laser rangefinder system 110 can relay the ballistics solution information to the RDA 160. In some examples, the laser rangefinder system 110 may relay the initial range to the RDA 160 and an RDA controller 540 can determine the ballistics solution.

The functionality at block 610 comprises finding a ballistics aimpoint based at least in part on the ballistics solution. In some examples, the ballistic aimpoint can include x and y coordinates based on an optical scope 130 reticle origin for the xy coordinate system. In some examples, the ballistic aimpoint can be determined with the processing unit of the laser rangefinder system 110 and the ballistic aimpoint information can be transmitted to the RDA 160. In some examples, the RDA controller 540 can determine the ballistics aimpoint.

At block 612, the functionality comprises illuminating the display of the RDA 160 configured to display the target. The illuminated display can be visible to a user. In some examples, the display is activated by illuminating the display using a visible light source. In some examples, the visible light source can be a red light emitting diode (LED) 550 and the display can be a liquid crystal on silicon (LCOS) display 560. The RDA 160 can be bore-sighted to the optical scope 130. In some examples, the display can include an xy coordinate system with a location of the optical scope reticle included on the display as the origin of the xy coordinate system.

The functionality at block 614 comprises marking the ballistics aimpoint with an electronic reticle 570 on the display. In some examples, the ballistics aimpoint can include x and y coordinates and the display can place the electronic reticle 570 at the x and y coordinates of the ballistics aimpoint. The electronic reticle 570 can be visible to the user and can aid in aligning the second laser beam 430 with the ballistics aimpoint.

At block 616, the functionality comprises redirecting the first laser beam 420 to the ballistics aimpoint using the center portion 260 of the one or more rotatable Risley prisms. Further, at block 618, the second laser beam 430 is redirected to the ballistics aimpoint using the annulus 270 of the one or more rotatable Risley prisms. In some examples, the laser rangefinder system 110 redirects the first 420 and second laser beams 430 automatically based on the ballistics aimpoint. As noted in the embodiments above, the wedge angles of the center portion 260 and annulus 270 may be tuned to the particular wavelengths of the first laser beam 420 and second laser beam 430, respectively, thereby being configured to redirect the two laser beams in substantially the same outgoing direction. Moreover, this outgoing direction can change upon rotational movement of the one or more rotatable Risley prisms. In some embodiments, the first wavelength may comprise a wavelength of 1550 nm. Additionally, or alternatively, the second wavelength may comprise a wavelength of 633 nm, which is in the visible range. In some examples, a beam with a visible wavelength and the electronic reticle 570 can aid the user in confirming that the laser beams are aligned with the ballistics aimpoint.

In some embodiments, such as when the RDA 160 and the laser rangefinder system 110 are combined in the same housing, the first laser beam 420 (as well as other laser beams) can be redirected based on the angular frame of reference of the LCOS display 560 relative to the optical scope reticle as well as the first laser beam 420. The RDA controller 540 can correlate movement of the first laser beam 420 (as well as the other laser beams) to movement of an image of the first laser beam 420 on the LCOS display 560 in units of pixels. For example, when the first laser beam 420 is moved 1 milliradian to the left, this can correlate in a movement of the image of the first laser beam on the LCOS display 560 several pixels. When the angular resolution of the RDA 160 is 50 micro-radians, then the number of pixels is 20 pixels (1000/50). In this example, when the first laser beam 420 is to be repositioned left 1 milliradian, from the present position, the RDA controller 540 recognizes that the first laser beam 420 is to be moved 20 pixels to the left on the LCOS display 560, and vice versa. An angular transfer function of the Risley prism can be triggered to convert the 1 milliradian repositioning of the first laser beam 420 into steps of a step motor until the LCOS display 560 detects a movement of 20 pixels of the image of the first laser beam 420 on the LCOS display 560.

As noted in FIGS. 4A-4B, embodiments may include three (or more) lasers. Thus, some embodiments may further include receiving, at the Risley prism assembly of the laser rangefinder, a third laser 410 configured to emit a third laser beam 425 having a third wavelength in between the first wavelength and the second wavelength. These embodiments may further include redirecting the second laser beam 430 using a second annulus 450. These embodiments may further include redirecting the third laser beam 425 using a first annulus 445 of the one or more rotatable Risley prisms, wherein a wedge angle of the second annulus 450 is less than a wedge angle of the first annulus 445. In some examples, the third wavelength may comprise a wavelength of 880 nm.

Some embodiments may further include receiving, at the Risley prism assembly of the laser rangefinder, a fourth laser configured to emit a fourth laser beam having a fourth wavelength. In some examples, the fourth wavelength can be equivalent to the third wavelength. These embodiments may further include redirecting the fourth laser beam using the first annulus 445 of the one or more rotatable Risley prisms.

The functionality at block 620 comprises upon redirect of the first laser beam 420, detecting, with the receiver unit 520, a secondary reflected laser light from the first laser beam 420. In some examples, the reflected laser light can comprise a plurality of reflected laser pulses corresponding to a plurality of laser pulses transmitted with a fiber laser reflecting off a target, wherein the receiver unit directs the reflected laser light toward a light sensor.

The functionality at block 622 comprises calculating an secondary range to the target based at least in part on the detecting of the secondary reflected laser light. The range can be determined based on the time at which the secondary reflected laser light was detected by the light sensor. Since the first laser 405 has been redirected, the secondary range can be different than the initial range. In some examples, utilization of a plurality of laser pulses can provide for a particularly accurate range determination. For example, the determination of the distance from the laser rangefinder system 110 to the target may be based on an average time of flight of the plurality of laser pulses.

In some examples, the method 600 can further comprise determining an updated ballistics solution based at least in part on the secondary range. A new ballistics aimpoint can be determined based on the updated ballistics solution. The electronic reticle 570 can be repositioned to mark the new ballistics aimpoint and each of multiple laser beams can be redirected to the new ballistics aimpoint. The method can further comprise tracking the target by continuously updating the ballistics solution and ballistics aimpoint.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made only by way of example and not as limitation on the scope of the disclosure.

What is claimed is:

1. A method for multi-laser bore-sighting of a ballistic solution aimpoint, the method comprising:
receiving, at a Risley prism assembly of a laser rangefinder, a first laser beam having a first wavelength and a second laser beam having a second wavelength smaller than the first wavelength, wherein:
the Risley prism assembly comprises one or more rotatable Risley prisms having a center portion and an annulus; and
the center portion has a wedge angle greater than a wedge angle of the annulus;
detecting, with a receiver unit of the laser rangefinder, reflected laser light from the first laser beam;
calculating an initial range to a target based at least in part on the detecting of the reflected laser light;
determining a ballistics solution based at least in part on the initial range;
finding a ballistics aimpoint based at least in part on the ballistics solution;
illuminating a display of a riflescope display assembly (RDA) configured to display the target;
marking the ballistics aimpoint with an electronic reticle on the display;
redirecting the first laser beam to the ballistics aimpoint using the center portion of the one or more rotatable Risley prisms;
redirecting the second laser beam to the ballistics aimpoint using the annulus of the one or more rotatable Risley prisms;
upon redirecting the first laser beam, detecting, with the receiver unit, secondary reflected laser light from the first laser beam; and
calculating a secondary range to the target based at least in part on the detecting of the secondary reflected laser light.

2. The method of claim 1, wherein the first wavelength is 1550 nm.

3. The method of claim 1, wherein the second wavelength is 633 nm.

4. The method of claim 1, wherein each rotatable Risley prism of the one or more rotatable Risley prisms comprises a respective larger optical wedge coupled with a respective smaller optical wedge.

5. The method of claim 4, wherein, for each rotatable Risley prism of the one or more rotatable Risley prisms, the respective larger optical wedge is coupled with the respective smaller optical wedge such that:
the center portion of the respective rotatable Risley prism comprises a portion where the respective smaller optical wedge is coupled with the respective larger optical wedge; and
the annulus of the respective rotatable Risley prism comprises a portion where the respective larger optical wedge overlaps the respective smaller optical wedge.

6. The method of claim 5, wherein the annulus comprises a second annulus, the method further comprising:
receiving, at the Risley prism assembly of the laser rangefinder, a third laser configured to emit a third laser beam having a third wavelength in between the first wavelength and the second wavelength; and
redirecting the third laser beam using a first annulus of the one or more rotatable Risley prisms, wherein a wedge angle of the first annulus is greater than the wedge angle of the second annulus.

7. The method of claim 6, further comprising:
receiving, at the Risley prism assembly of the laser rangefinder, a fourth laser configured to emit a fourth laser beam having a fourth wavelength equal to the third wavelength; and
redirecting the fourth laser beam using the first annulus of the one or more rotatable Risley prisms.

8. The method of claim 6, wherein the third wavelength is 880 nm.

9. The method of claim 1, further comprising:
determining an updated ballistics solution based at least in part on the secondary range; and
finding a new ballistics aimpoint based on the updated ballistics solution.

10. The method of claim 9, further comprising tracking the target by continuously updating the ballistics solution and the ballistics aimpoint.

11. A multi-laser bore-sighting riflescope system comprising:
a laser rangefinder comprising:
a first laser configured to emit a first laser beam having a first wavelength, and
a second laser configured to emit a second laser beam having a second wavelength shorter than the first wavelength; and
a Risley prism assembly comprising one or more rotatable Risley prisms having a center portion and an annulus, wherein the center portion has a wedge angle greater than a wedge angle of the annulus; wherein:
the first laser is configured to emit the first laser beam through the enter portion of the one or more rotatable Risley prisms, and
the second laser is configured to emit the second laser beam through the annulus of the one or more rotatable Risley prisms; and
a riflescope display assembly (RDA) comprising a display configured to display a target, the display comprising an electronic reticle configured to mark a ballistics aimpoint.

12. The multi-laser bore-sighting riflescope system of claim 11, wherein each rotatable prism of the one or more rotatable Risley prisms comprises a respective larger optical wedge coupled with a respective smaller optical wedge.

13. The multi-laser bore-sighting riflescope system of claim 12, wherein, for each rotatable Risley prism of the one or more rotatable Risley prisms, the respective larger optical wedge is coupled with the smaller optical wedge such that:
the center portion of the respective rotatable Risley prism comprises a portion where the respective smaller optical wedge is coupled with the larger optical wedge; and
the annulus of the respective rotatable Risley prism comprises a portion where the respective larger optical wedge overlaps the respective smaller optical wedge.

14. The multi-laser bore-sighting riflescope system of claim 11, wherein the first wavelength is 1550 nm.

15. The multi-laser bore-sighting riflescope system of claim 11, wherein the first wavelength is 633 nm.

16. The multi-laser bore-sighting riflescope system of claim 11, the laser rangefinder further comprising a third laser configured to emit a third laser beam having a third wavelength in between the first wavelength and the second wavelength, wherein:
the annulus comprises a second annulus;
the one or more rotatable Risley prisms comprise a first annulus;
a wedge angle of the first annulus is greater than the wedge angle of the second annulus; and
the third laser is configured to emit the third laser beam through the first annulus of the one or more rotatable Risley prisms.

17. The multi-laser bore-sighting riflescope system of claim 16, the laser rangefinder further comprising a fourth laser configured to emit a fourth laser beam having a fourth wavelength equivalent to the third wavelength, wherein the fourth laser is configured to emit the fourth laser beam through the first annulus of the one or more rotatable Risley prisms.

18. The multi-laser bore-sighting riflescope system of claim 16, wherein the third wavelength is 880 nm.

19. The multi-laser bore-sighting riflescope system of claim 11, the laser rangefinder further comprising:
a receiver unit configured to detect reflected laser light from the first laser beam and provide output data; and
a processing unit configured to calculate a range based at least in part on the output data from the receiver unit.

20. The multi-laser bore-sighting riflescope system of claim 19, the laser rangefinder further comprising an output interface configured to provide an indication of the calculated range.
